(19) United States
(12) Patent Application Publication
(10) Pub. No.: US 2004/0117406 A1
(43) Pub. Date: Jun. 17, 2004

(54) Method and system for media exchange network functionality accessed via media processing system key code entry

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,193

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/445,933, filed on Feb. 7, 2003.

(51) Int. Cl. G06F 7/00

(52) U.S. Cl. 707/104.1

(57) ABSTRACT

Certain aspects of the invention may be found in a method for providing on a television screen within a home, access to selected ones of a plurality of media files stored outside of the home. A plurality of key sequences may be associated outside of the home with a corresponding plurality of media files and a key sequence received via manual input from within the home. Media files corresponding to one or more associated key sequences may be communicated for display on the television screen. If the received key sequence is associated with an existing function for media exchange, then at least one media file associated with a function for media exchange may be requested, received and/or displayed on the television screen. Users may also be notified of key sequences that may be associated with a function for media exchange.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001P-BP-2800) filed Dec. 11, 2002;

U.S. Provisional Application Serial No. 60/443,894 (Attorney Docket No. 14274US01 01002P-BP-2801) filed Jan. 30, 2003;

U.S. Provisional Application Serial No. 60/457,179 (Attorney Docket No. 14825US01 01015P-BP-2831) filed Mar. 25, 2003; and

U.S. Provisional Application Serial No. 60/445,933 (Attorney Docket No. 14307US01 01014P-BP-2815) filed Feb. 7, 2003.

This application also makes reference to:

U.S. application Ser. No. ______ (Attorney Docket No. 14185US02 01001P-BP-2800) filed Sep. 8, 2003;

U.S. application Ser. No. ______ (Attorney Docket No. 14274US02 01002P-BP-2801) filed Sep. 11, 2003;

U.S. application Ser. No. ______ (Attorney Docket No. 14306US02 01013P-BP-2814) filed Sep. 30, 2003; and

All of the above stated applications are incorporated herein by reference in their entirety.

### FIELD OF THE INVENTION

Certain embodiments of the invention relate to media functionality. In particular, certain embodiments of the invention relate to a method and system for providing functionality that is accessed via a key code entry on a media exchange network.

### BACKGROUND OF THE INVENTION

In current systems, broadcasters generally provide basic television programming media to users. This may include point-to-point communication or point-to-multipoint communication such as cable broadcasting and satellite broadcasting. In this regard, all functional aspects of the broadcasting are fully controlled by the broadcasters and such control occurs independent of the user. For example, a broadcaster of a live broadcast may typically control the program views that are broadcast at any given time. A user or subscriber located at an access point such as a home simply views the program views content that may be broadcast to the user or subscriber by the broadcaster. Accordingly, in this manner the program views are independently broadcasted, received and viewed by the user or subscriber.

Televisions (TVs) and set-top boxes may provide certain functionality to a user that may be independent of the broadcasters and the broadcast media being provided. For example, a user of a television may control or set the volume of a particular broadcast channel to a particular level by increasing or decreasing a volume associated with the broadcast. However, when the user selects another broadcast channel, the volume associated with the received media will differ from the volume that was previously set by the user. In this regard, since the volume control functionality is internal to the television and is not a part of the actual media that is being broadcasted, the volume setting established by the user is independent of the received broadcast media.

Furthermore, a user may record a broadcast media and then later playback the broadcast media and utilize certain functions such as fast forward, slow forward, rewind, slow rewind, fast rewind, for example. These functions are independent of the broadcaster and the broadcast media and are only a function of, for example, a television, a VCR or a set-top box.

Currently, third (3^{rd}) party media providers hosting web sites on the Internet provide digital media content such as digital video, digital images, digital audio and text. A personal computer (PC) may be utilized to access the media content on the web sites. In addition, the third (3^{rd}) party providers of these web sites often provide certain types of user selectable functionality. For example, a user of a personal computer may view a web site showing a video clip of a sports figure being interviewed. The web site may provide sales interaction functionality that allows the user of the personal computer to select and purchase, for example, a football jersey with a sports figure's number affixed or other memorabilia. Such functionality is fairly common in the Internet and intranets that are accessible by a personal computer or other access device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain aspects of the invention may be found in a method for providing on a television screen within a home, access to selected ones of a plurality of media files stored outside of the home. The method may comprise associating, outside of the home, a plurality of key sequences with a corresponding plurality of media files and receiving one of the key sequences via manual input within the home. One of the media files corresponding to one or more of the associated key sequences may be communicated for display on the television screen. The method may also comprise determining whether the received key sequence is associated with an existing function for media exchange. If so, then at least one media file associated with an existing function for media exchange may be requested, received and/or displayed on the television screen. Also, users may be notified of key sequences that may be associated with a function for media exchange.

Another embodiment of the invention may provide a machine-readable storage, having stored thereon, a computer program having at least one code section for providing on a television screen within a home, access to selected ones of a plurality of media files stored outside of the home. The at least one code section may be executable by a machine, thereby causing the machine to perform the steps as described above for providing on a television screen within a home, access to selected ones of a plurality of media files stored outside of the home.

Certain embodiments of the invention may also be found in a method and a system for providing media content. Aspects of the method may include receiving a key code corresponding to at least one media exchange function associated with a media program generated by a third (3^{rd}) party that provides media or media provider. The function for media exchange may be referred to as a media exchange function or a media program function. The key code and/or data representative of the key code may be communicated to the third (3^{rd}) party media provider. In response to communicating the key code and/or data representative of the key code to the third (₃rd) party media provider, media content corresponding to the key code and a media exchange function may be received from at least the third (3^{rd}) party media provider. In another aspect of the invention, a determination may be made as to whether or not the key code is associated with an existing media exchange function. If the key code is associated with an existing media exchange function, media content corresponding to the key code and/or a media exchange function may be requested and/or received from the third (3^{rd}) party media provider. If the key code is unassociated with an existing media exchange function, the creation of a new media exchange function corresponding to the key code may be initiated.

In another aspect of the invention, the method may include facilitating transfer of the received media content corresponding to the key code and media exchange function from the third (3^{rd}) party media provider to a media processing system. At least a portion of the received media content corresponding to the key code and media exchange function may be presented to a user. In this regard, at least a portion of the received media content corresponding to the key code and media exchange function may be displayed on a television screen of and/or coupled to the media processing system. A user may also be notified of the availability of the key code associated with a media program generated by the third (3^{rd}) party media provider. The key code may be generated by a remote control device, a keyboard, a scanning device, an audio processing device or a combination thereof.

Aspects of the system for providing media content may include at least one processor that may receive a key code corresponding to at least one media exchange function associated with a media program generated by a third (3^{rd}) party media provider. The processor may communicate the key code and/or data representative of the key code to the third (3^{rd}) party media provider. In response to the communicated key code and/or data representative of the key code, the processor may receive media content corresponding to the key code and at least one media exchange function from at least the third (3^{rd}) party media provider. In another aspect of the invention, the processor may determine whether the key code is associated with an existing media exchange function. If the key code is associated with the existing media exchange function, the processor may request the received media content corresponding to the key code and media exchange function from the third (3^{rd}) party media provider. In instances where the key code is unassociated with an existing media exchange function, the processor may initiate the creation of a new media exchange function corresponding to the key code.

In another aspect of the invention, the processor may facilitate transfer of the received media content corresponding to the key code and media exchange function from the third (3^{rd}) party media provider to a media processing system. The processor may also be adapted to cause at least a portion of the received media content corresponding to the key code and media exchange function to be presented to a user. In this regard, the processor may cause at least a portion of the received media content corresponding to the key code and media exchange function to be displayed on a television screen of or coupled to the media processing system. A user may also be notified by the processor of availability of a key code associated with a media program generated a third (3^{rd}) party media provider. The processor may also be adapted to receive the key code generated by a remote control device, a keyboard, a scanning device, an audio processing device or a combination thereof. The processor may be a media processing system processor, a media management system processor, a computer processor, a media exchange software processor, a media peripheral processor or a combination thereof.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram of a media exchange network that may be utilized in conjunction with functionality that may be accessed via a media processing system by entering a key code, in accordance with an embodiment of the invention.

FIG. 2A is a flowchart illustrating an embodiment of a method 200 that may be utilized to access functionality offered by a third (3^{rd}) party media provider via a media processing system 101 on the media exchange network 100 of FIG. 1, in accordance with various aspects of the present invention.

FIG. 2B is a flow chart illustrating exemplary steps that may be utilized for providing media exchange functionality that may be accessed by a key code in accordance with an embodiment of the invention.

FIG. 2C is a flow chart illustrating exemplary steps that may be utilized for providing media exchange functionality that may be accessed by a key code in accordance with an embodiment of the invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain aspects of the invention may be found in a method for providing on a television screen within a home, access to selected ones of a plurality of media files stored outside of the home. The method may comprise associating, outside of the home, a plurality of key sequences with a corresponding plurality of media files and receiving one of the key sequences via manual input within the home. Media files corresponding to one or more associated key sequences may be communicated for display on the television screen. A determination may be made as to whether the received key sequence is associated with an existing function for media exchange. If the received key sequence is associated with an existing function for media exchange, then at least one media file associated with a function for media exchange may be requested, received and/or displayed on the television screen. Users may also be notified of key sequences that may be associated with a function for media exchange.

Certain embodiments of the invention may also be found in a method and system for providing functionality that may be accessed via a key code entry on a media exchange network. In this regard, a key code may be a numeric code, a symbol code, an alpha-numeric code, an alphabetized code or any combination thereof in accordance with various embodiments of the invention. Aspects of the invention may comprise receiving a key code corresponding to at least one media exchange function associated with a media program generated by a third (3^{rd}) party media provider. The media exchange function may also be referred to as a media program function. The key code and/or data representative of the key code may be communicated to the third (3^{rd}) party media provider and in response, media content corresponding to the key code and a media exchange function may be received from at least the third (3^{rd}) party media provider. The received media content may include media provided by at least the third (3^{rd}) party media provider.

Aspects of the invention may comprise determining whether or not the key code is associated with an existing media exchange function. If the key code is associated with an existing media exchange function, media content corresponding to the key code and media exchange function may be requested and/or received from the third (3^{rd}) party media provider. However, in instances where the key code is unassociated with an existing media exchange function, the creation of a new media exchange function corresponding to the key code may be initiated.

Other aspects of the invention may comprise facilitating transfer of the received media content corresponding to the key code and media exchange function from the third (3^{rd}) party media provider to a media processing system. At least a portion of the received media content corresponding to the key code and media exchange function may be presented to a user. Accordingly, received media content corresponding to the key code and media exchange function may be displayed on a television screen of and/or coupled to the media processing system. A user may also be notified of the availability of one or more key codes that may be associated with a media program generated by the third (3^{rd}) party media provider. The key code may be generated by a remote control device, a keyboard, a scanning device, an audio processing device or other data input device, or a combination thereof.

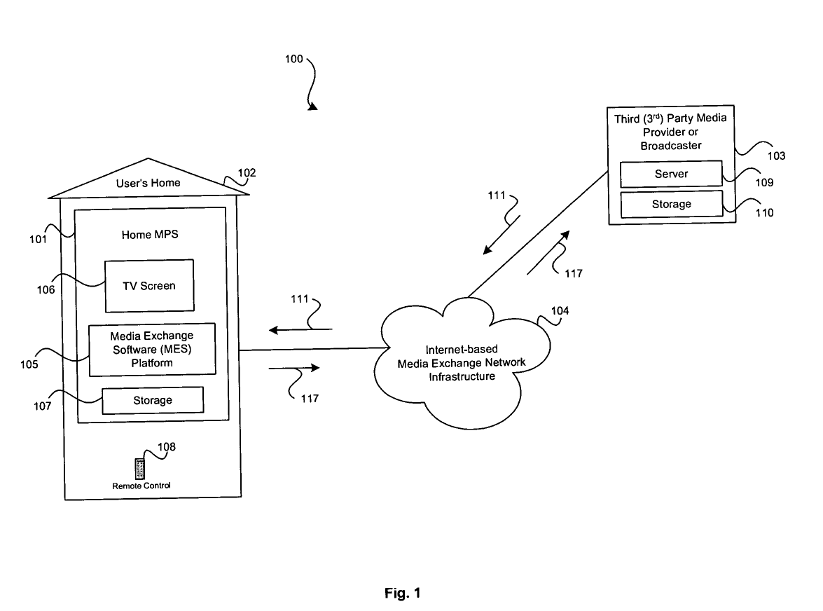

FIG. 1 is a diagram of a media exchange network 100 that may be utilized in conjunction with functionality that may be accessed via a media processing system by entering a key code, in accordance with an embodiment of the invention. Referring to FIG. 1, the media exchange network 100 may include a user location which may be a user's home 102, an Internet-based media exchange network infrastructure 104 and a third (3^{rd}) party media provider or broadcaster 103.

The user location or user's home 102 may include a home media processing system (MPS) 101 and a remote control 108. The Internet-based media exchange network infrastructure 104 provides connectivity between the media processing system 101 and the third (3^{rd}) party broadcaster 103. In the exemplary embodiment of FIG. 1, since the media processing system 101 is located at the user's home, it may be referred to as a home media processing system 101.

The media processing system 101 may include a media exchange software (MES) platform 105, a TV screen 106 and a storage block 107. The media exchange software platform 105 may provide certain functionality within the media processing system 101, which may include, but is not limited to, the ability to receive and process broadcast media content and associated synchronized functionality from the media exchange network 100. The media exchange software platform 105 may also provide a user with the capability to enter or otherwise receive a key code that may activate a media exchange function. In response, media associated with the key code may be pushed or otherwise communicated via the Internet-based media exchange network infrastructure 104 and received by the user via the media processing system 101.

The media exchange software platform 105 may also provide a user of the media processing system 101 with the capability to control one or more media exchange functions associated with a media program using, for example, the remote control 108. In this regard, the remote control 108 may be adapted to generate a user input comprising a key code that may be utilized to activate or initiate one or more media exchange functions provided to the media processing system 101 from the third (3^{rd}) party media provider 103. The remote control 108 may communicate in a wireless manner with the media processing system 101 via infrared or RF signals, in accordance with various embodiments of the invention. In an exemplary embodiment of the invention, the remote control may be utilized by a user to enter and/or select a key code associated with a media exchange function. Accordingly, this entered and/or selected key code may be utilized to activate an existing functionality and/or initiate a new functionality. A user may store key codes in a memory of the remote control 108 or within the media processing system 101. These stored key codes may be recalled and/or selected whenever they may be required.

Although the remote control 108 may be utilized to control at least some of the media exchange functionalities of the media processing system 10 and/or the media exchange network 100, the invention is not so limited. Accordingly, the user may utilize other devices that may function as I/O devices and/or navigational tools to control the media exchange functionality of the media processing system 101. For example, a mouse, a touch-screen TV display, and/or a keyboard may be utilized to control the media exchange functionality of the media processing system 101. The keyboard may be a software keyboard or a hardware keyboard. In accordance with another aspect of the invention, a special code reading device may be utilized to scan, read and/or interpret various synchronized functionality codes that may be displayed on the TV screen 106. The special code reading device may also have the capability to scan key codes associated with one or more media exchange functionalities. The key code may be found in print media including, but not limited to, magazines, newspapers, books and charts. The key codes may also be represented in an electronic format.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The communication infrastructure 105 may include cable infrastructure, xDSL infrastructure, satellite network infrastructure, Internet infrastructure, intranet infrastructure or other similar access and/or transport infrastructure. In this regard, the Internet-based media exchange network infrastructure 104 may provide access and/or transport functionality that may facilitate the exchange of media between, for example, the user's home 102 and the third (3^{rd}) party broadcaster or provider 103. The intranet infrastructure which may be part of the Internet-based media exchange network infrastructure may also be adapted to providing wide area network (WAN) capability.

The third (3^{rd}) party media provider or broadcaster 103 may supply third (3^{rd}) party media content to user locations such as the user's home 102 via the Internet-based media exchange network infrastructure. The supplied third (3^{rd}) party media content may include media. The ₃rd party media provider 103 may also provide media exchange functions that may be requested and/or activated by a user through the use of a key code. In this regard, various media exchange functions may be mapped to a particular key code. Accordingly, an entered or inputted key code may be utilized to activate and/or initiate a corresponding media exchange function. The third (3^{rd}) party media provider or broadcaster 103 may include a server 109 and a storage block 110.

The server 109 may be, for example, a file-based server and may be implemented as part of or an adjunct to a personal computer (PC) and/or a mainframe computer system. The server 109 may also be a web server. Notwithstanding, the server 109 may have the capability to push or otherwise communicate media content that is stored in the storage block 110 to the media processing system 101 via the Internet-based media exchange network infrastructure 104. In accordance with an aspect of the invention, the server 109 may also be configured to provide media exchange functionality 111 to user's of the media exchange network 100 through the use of a key code.

The storage block 110 may be utilized to store media content provided by the (3^{rd}) party media provider or broadcaster 103. The storage block 110 may include, but is not limited to, a database, a CD tower, a jukebox, a magnetic disk, an optical disk, a magneto-optical disk, a solid state memory device, a tape device, a media peripheral, a server, a media processing system and a computer having various memory and/or storage devices.

The media processing system 101 may have the capability to transfer a key code 117 to the third (3^{rd}) party media provider 103 and in response, receive media content associated with at least one corresponding media exchange function 111 from the third (3^{rd}) party media provider 103, in accordance with various embodiments of the present invention. The received media content associated with a particular media exchange function may be dependent on an input key code, for example. The TV screen 106 of the media processing system 101 may provide a user with the capability to view the received media content and any other synchronized or unsynchronized functionality 111. The received media content may include media activated or initiated by a key code. A notification associated with the synchronized or unsynchronized functionality options from the third (3^{rd}) party media provider 103 may be displayed on the TV screen 106 of the media processing system 101. In this regard, notifications pertaining to the availability of key codes may be displayed on the TV screen 106. The notification may be automatically displayed or it may be displayed based on user interaction. For example, the user interaction may include the pushing of a button on the remote control 108 by a user of the media processing system 101. In this regard, the user may choose when to view the notification and may even decide what types of notification should be received and when they should be received.

In accordance with an embodiment of the present invention, synchronized or unsynchronized functionality may be provided by the 3^{rd} party broadcaster 103 along with a media broadcast. The synchronized functionality may include at least one media exchange function that may be selectable by a user using a key code. In other words, while a user's media processing system 101 may be displaying an audio, video and/or data representation of a real-time media broadcast, a media exchange function related to the media broadcast may be made available to the user, either automatically or through user interaction. In any case, upon selection, activation or initiation of a media exchange function by a user utilizing a key code, media content may be communicated from the third (3^{rd}) party media provider or broadcaster to the user. In this regard, the media content associated with the media exchange function may be transferred from the third (3^{rd}) party media provider or broadcaster 103 to the user based on the key code.

In an embodiment of the invention, the television screen 106 of the media processing system 101 may be adapted to receive an input key code. The input key code 117 may be transferred from the media processing system 101 to the third party (3^{rd}) party media provider 103 via the Internet-based media exchange network infrastructure 104. Upon receipt of the key code, the third (3^{rd}) party media provider 103 may decode or decipher the key code to determine its associated media exchange function. After the key code has been decoded or deciphered, the third (3^{rd}) party media provider 103 may acquire media content associated with the media exchange function from, for example, the storage block 110 or the web server 109. In any case, the third (3^{rd}) party media provider 103 may transfer the media content associated with the existing or new media exchange function to the media processing system 101 via the Internet-based media exchange network infrastructure 104. The media content may include media.

In an alternate embodiment of the invention, the television screen 106 of the media processing system 101 may be adapted to receive an input key code. The input key code may be processed by the media processing system 101 and a corresponding request to activate an existing functionality or initiate a new functionality may be generated by the media processing system 101. This processing of the key code may include decoding or deciphering the key code to determine an associated media exchange function. Notwithstanding, the request to activate or initiate a media exchange function associated with the key code may be transferred from the media processing system 101 to the third (3^{rd}) party media provider 103 via the Internet-based media exchange network infrastructure 104. Upon receipt of the request to activate the existing media exchange function or to initiate the new media exchange function, the third (3^{rd}) party media provider 103 may transfer media associated with the requested media exchange function to the media processing system 101 via the Internet-based media exchange network infrastructure 104.

The media exchange function activated or initiated by the key code may provide a user or subscriber with the capability to request supplemental information related to the media content associated with a particular media broadcast. Accordingly, the user may have the capability to request that the media broadcast or portions thereof be delivered in a different language or in a different view by utilizing a key code. Hence, a user or subscriber may request that at least a portion of the media broadcast be presented in English, Spanish, and/or French, for example. In other exemplary aspect of the invention, a user or subscriber may have the capability to engage in sales interactions and request a related personal interview by utilizing a key code.

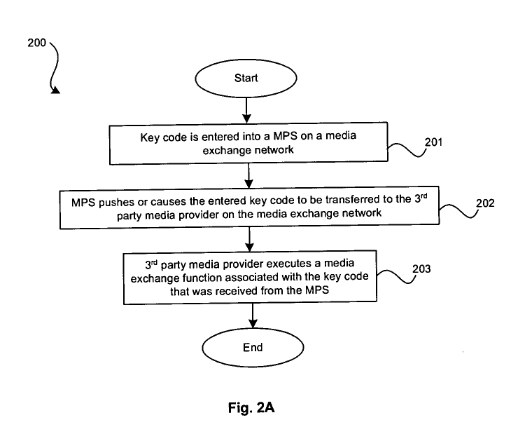

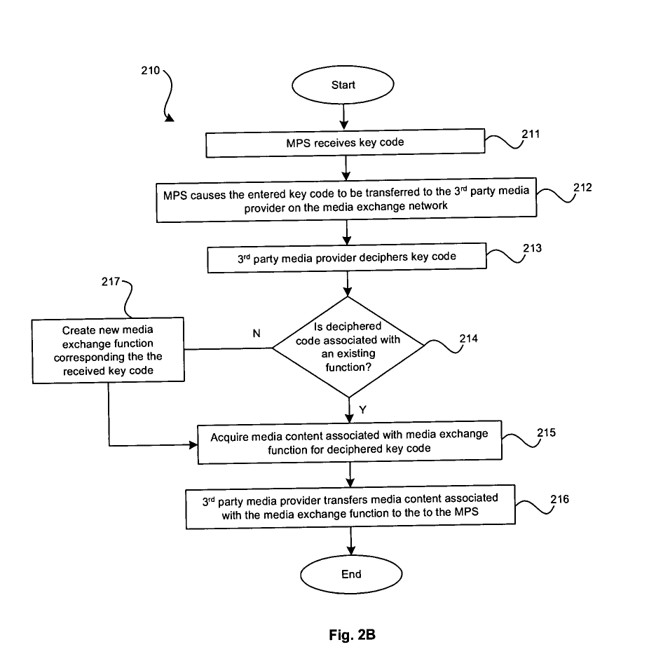

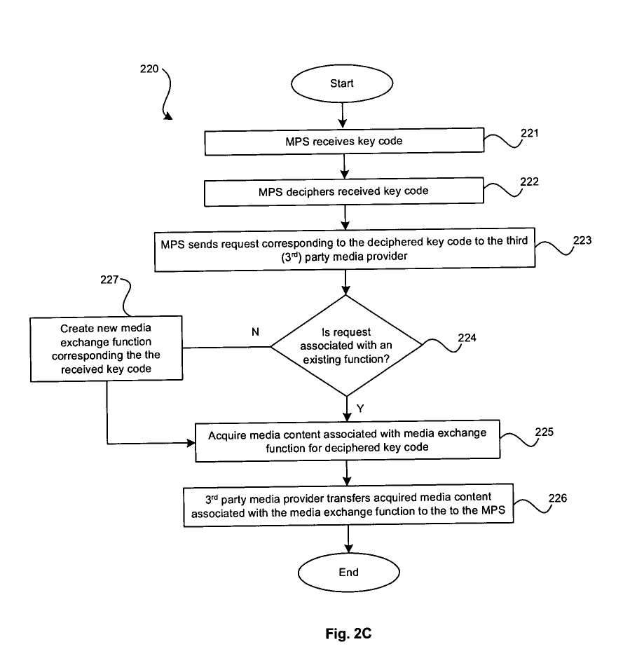

FIG. 2A is a flowchart illustrating an embodiment of a method 200 that may be utilized to access functionality offered by a third (3^{rd}) party media provider via a media processing system 101 on the media exchange network 100 of FIG. 1, in accordance with various aspects of the present invention. Referring to FIG. 2A, in step 201, a key code is entered into a media processing system on a media exchange network. The key code may correspond to an existing media exchange function offered by the third (3^{rd}) party media provider. In step 202, the media processing system pushes or causes the entered key code to be transferred to the third (3^{rd}) party media provider on the media exchange network. In step 203, the third (3^{rd}) party media provider executes a media exchange function associated with the key code that was received from the media processing system. Execution of the media exchange function may result in media corresponding to the media exchange function being transferred or otherwise provided from the third (3^{rd}) party media provider to the media processing system.

In an illustrative embodiment of the invention, a user of the media processing system 101 may be watching a football game on the TV screen 106 of the media processing system 101. The media content for the football game may be provided by the third (3^{rd}) party media provider or broadcaster 103 along with unsynchronized and/or synchronized functionality. While watching the football game on TV screen 106, the user may recall viewing an advertised key code 117 on a football related web site that may be utilized to change the broadcast view of a football game, for example. In other aspects of the invention, the key code may also be part of an advertisement in electronic and/or printed media formats. In this regard, the key code 117 may be associated with a media exchange function that facilitates changing a broadcast view of a football game. In any case, the user of media processing system 101 may find it desirable to see a main view of the football game other than the current view being offered by the third (3^{rd}) party media provider 103. The alternate view of the football game may differ at least in part from a current view being provided by the third (3^{rd}) party broadcaster 103 is currently providing. Notwithstanding, the user may utilize the remote control 108 to enter the corresponding key code 117 via the television screen 106. Upon receiving the entered key code, the media processing system may cause the entered key code to be transferred to the third (3^{rd}) party media provider. In response to receiving the key code and/or a representation of the key code, the third (3^{rd}) party media provider may then push or otherwise cause media content associated with the main view of the football game to be transferred to the media processing system 101. This media content associated with the main view may be viewed on the television screen or display 106, which may be coupled to the media processing system 101.

In another exemplary embodiment of the invention, a user of the media processing system 101 may have noticed that one of the media exchange functions available from the broadcaster is an interview with the quarterback of one of the teams participating in the football game. This interview may be accessed using a key code displayed in an advertisement by the third (3^{rd}) party media provider. The user may enter the key code 117 using, for example, the remote control device 108, into the media processing system 101. The media processing system 101 may transfer the key code to the third (3^{rd}) party media provider 103. Upon receipt of the key code and/or a representation of the key code, the third (3^{rd}) party media provider may push or cause media content associated with the interview to be communicated to the media processing system 101. The media content associated with the interview may be displayed, for example, in a picture-in-picture (PIP) window of the TV screen 106 while the user continues to watch the football game on the rest of the TV screen 106. The picture-in-picture window may be moveable and in this regard, the remote control 108, for example, may be utilized to move the picture-in-picture window across the TV screen 106 for a more flexible viewing experience.

In another aspect of the invention, based on a key code, the third (3^{rd}) party media provider or broadcaster 103 may provide supplemental information related to media content distributed to the media processing system 101. The supplemental information may include, but is not limited to, an author's name, an actor's name, a history associated with the media broadcast, and a version of the media broadcast. In this regard, a user of the media processing system 101 may utilize the remote control 108 to cause the media processing system 101 to display, for example, a menu or window on the TV screen 106. The menu may permit the entry of a key code that may be associated with particular supplemental information.

Subsequent to the entry or input of a key code associated with a desired supplemental information function, the key code or a representation of the key code may be sent over the media exchange network 100 to the third (3^{rd}) party media provider 103. In response to receiving the selection, the third (3^{rd}) party broadcaster 103 may push or otherwise cause the desired supplemental information to be communicated to the user of media processing system 101. The supplemental information may then be displayed on the TV screen 106 of the media processing system 101.

As part of the supplemental information, a third (3^{rd}) party broadcaster 103 may also provide supplemental information associated with a movie broadcast that may allow a user to purchase clothing of a kind and/or similar to that which may be worn and/or promoted by certain actors in the movie broadcast. This is an example of sales interaction that may take place on the media exchange network in accordance with an embodiment of the present invention. In this regard, various key codes may be provided, each of which may be associated with a particular sales interaction activity.

Key codes may also be provided that may permit a change in a currently received media content. Specifically, in another exemplary embodiment of the invention, a user may be viewing a movie in the English language on the media processing system 101 and may have a desire to switch the language to an alternate language. For example, a friend who may be visiting at the user's home 102 may have a desire to view the movie in French rather than in its current English format. The user, who may also be acquainted with the French language, may enter, for example, a “change language” key code 117 into the media processing system 101 via the remote control 106, for example. The “change language” key code 117 may be provided by the third (3^{rd}) party broadcaster 103 of the movie and may be viewable on the television screen 106.

Upon receiving the “change language” key code 117, the third (3^{rd}) party media provider 103 may determine that the language of the media content currently being presented should be change to the French language selection. Based on this determination, the third (3^{rd}) party media provider 103 may then push or otherwise cause French language audio, video and/or text to be communicated to the media processing system 101, where it may be viewed on the television screen 106. The language associated with the movie content may therefore be changed from English to French in accordance with an embodiment of the present invention.

FIG. 2B is a flow chart illustrating exemplary steps that may be utilized for providing media exchange functionality that may be accessed by a key code in accordance with an embodiment of the invention. Referring to FIG. 2B, in step 211, a media processing system receives a key code. In step 212, the media processing system causes the entered code to be transferred to the third (3^{rd}) party media provider on the media exchange network. In step 213, the third (3^{rd}) party media provider may decipher or otherwise identify the key code. In step 214, the third (3^{rd}) party media provider may determine whether the deciphered key code is associated with an existing media exchange function. If the deciphered key code is associated with an existing media exchange function, then in step 215, the third (3^{rd}) party media provider may acquire media content associated with the media exchange function for the deciphered code. In step 216, the third (3^{rd}) party media provider may transfer the acquired media content associated with the media exchange function to the media processing system.

If the deciphered key code is not associated with an existing media exchange function, then in step 217, the third (3^{rd}) party media provider may create new media exchange function corresponding to the received key code. Subsequent to step 217, in step 215, the third (3^{rd}) party media provider may acquire media content associated with the media exchange function for the deciphered code. Finally, in step 216, the third (3^{rd}) party media provider may transfer the acquired media content associated with the media exchange function to the media processing system. The media content transferred to the media processing system may include media that may be displayed on a television display coupled to the media processing system.

In another embodiment of the invention, the media processing system may be adapted to decipher or otherwise identify the function associated with a received key code. FIG. 2C is a flow chart illustrating exemplary steps that may be utilized for providing media exchange functionality that may be accessed by a key code in accordance with an embodiment of the invention. Referring to FIG. 2C, in step 221, a media processing system receives a key code. In step 222, the media processing system may decipher or otherwise identify the received key code. In step 223, the media processing system may send a request corresponding to the deciphered key code to the third (3^{rd}) party media provider.

In step 224, the third (3^{rd}) party media provider may determine whether the request corresponding to the key code is associated with an existing media exchange function. If the request is associated with an existing media exchange function, then in step 225, the third (3^{rd}) party media provider may acquire media content associated with the media exchange function for the deciphered code. In step 226, the third (3^{rd}) party media provider may transfer the acquired media content associated with the media exchange function to the media processing system.

If the request corresponding to the key code is not associated with an existing media exchange function, then in step 227, the third (3^{rd}) party media provider may create new media exchange function corresponding to the received key code. Subsequent to step 227, in step 225, the third (3^{rd}) party media provider may the acquire media content associated with the media exchange function for the deciphered code. Finally, in step 226, the third (3^{rd}) party media provider may transfer the acquired media content associated with the media exchange function to the media processing system. The media content transferred to the media processing system may include media that may be displayed on a television display coupled to the media processing system.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

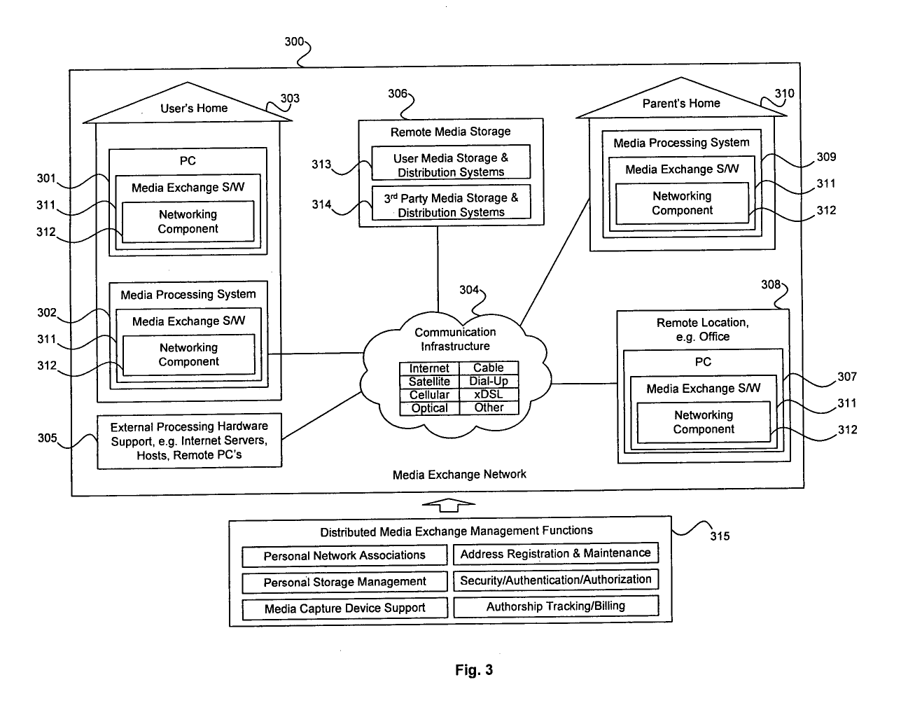

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

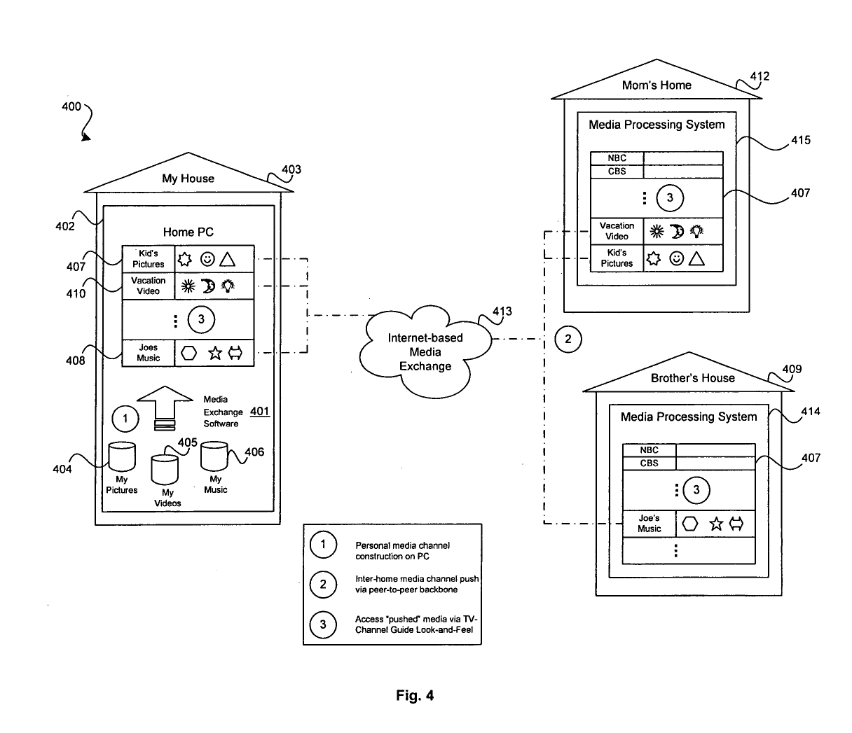

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

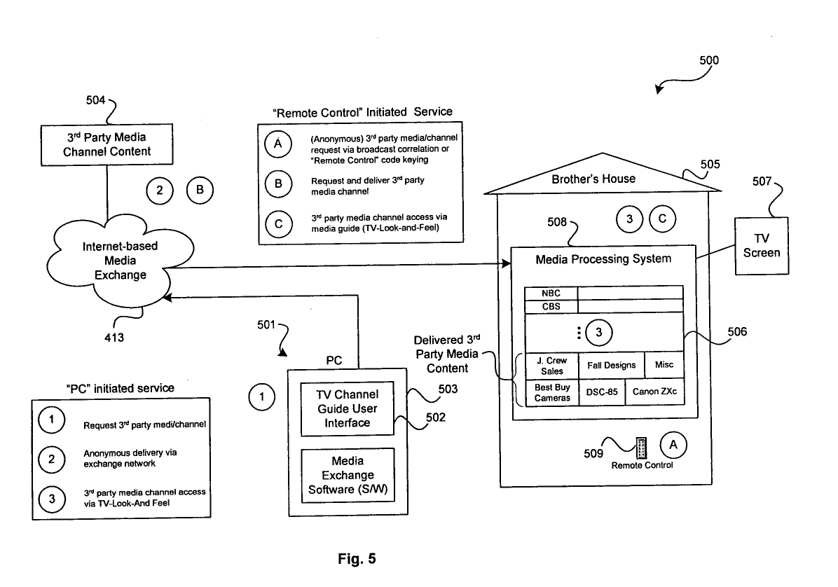

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

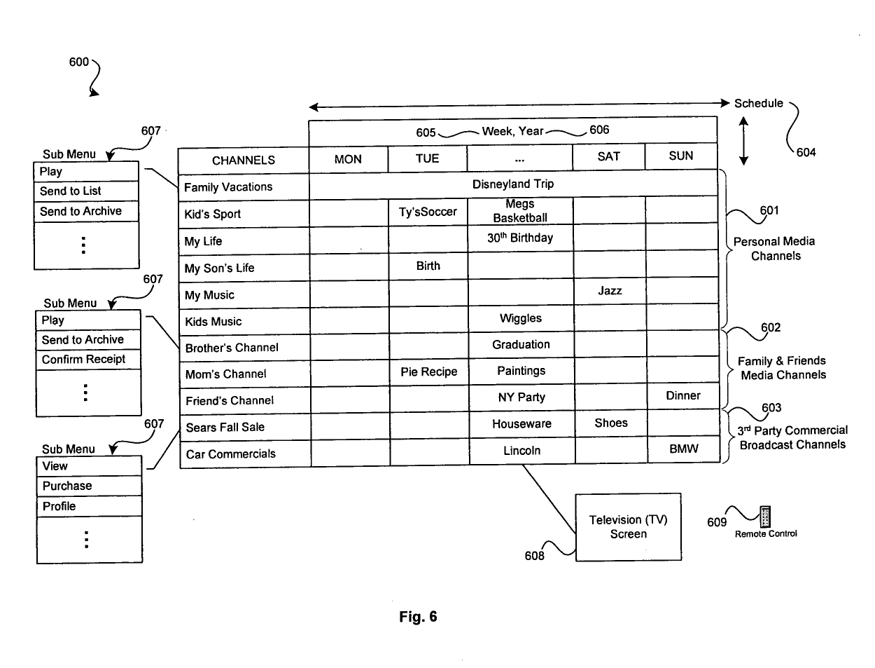

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

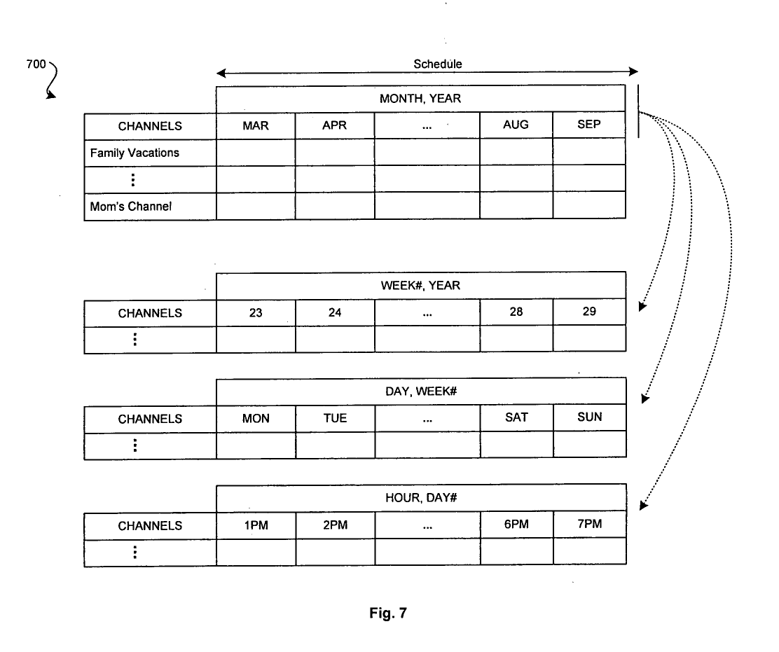

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

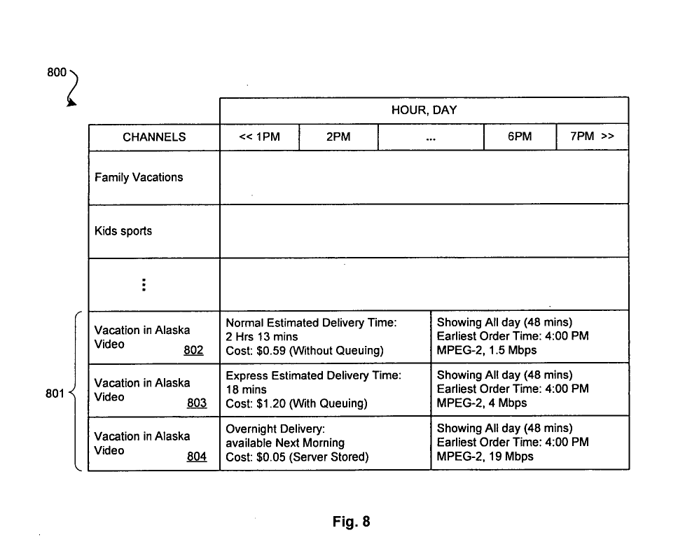

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

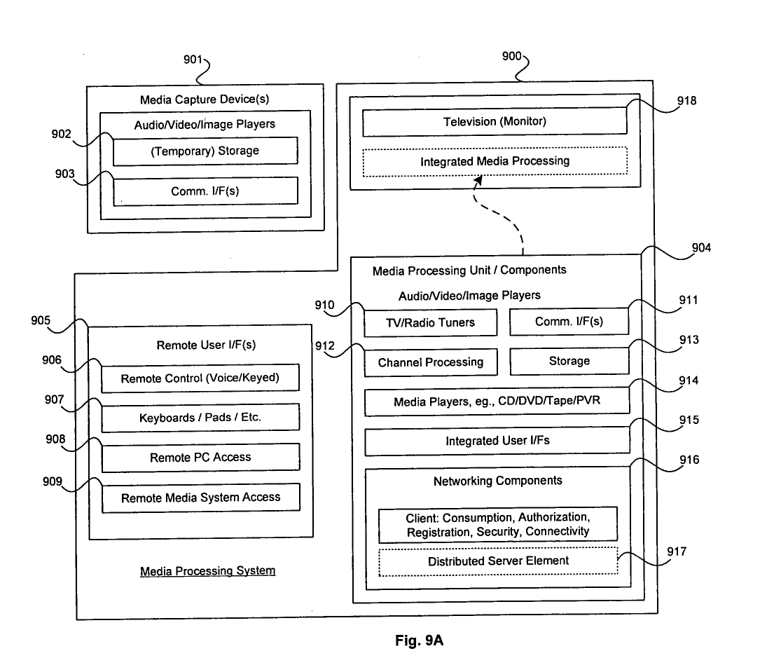

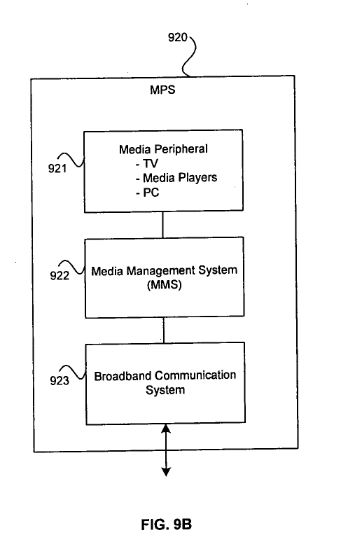

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

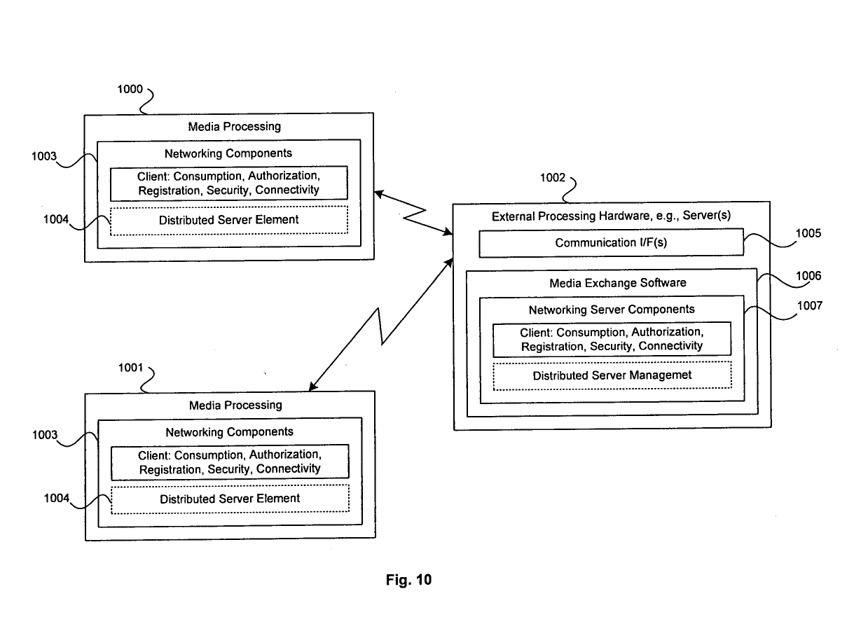

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

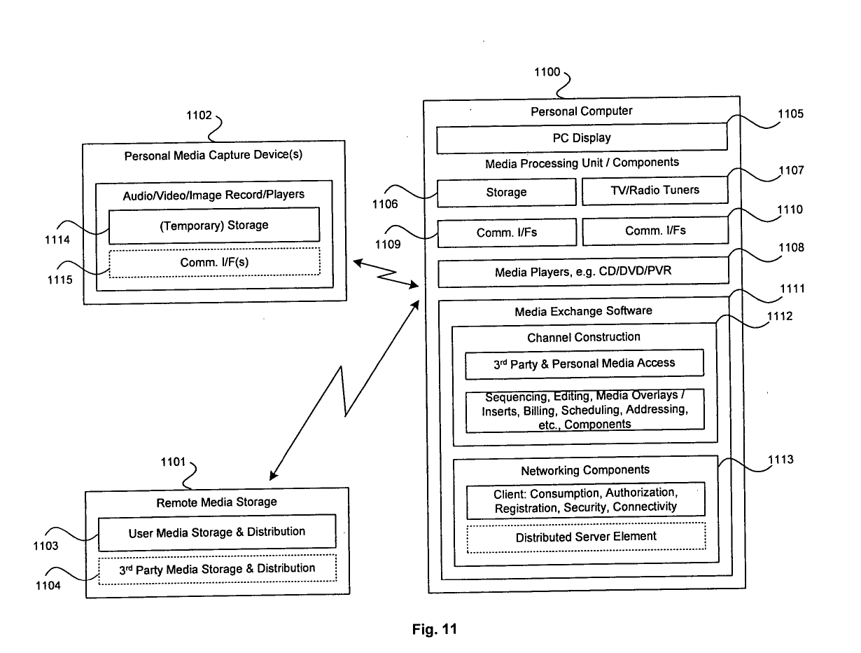

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In accordance with various aspects of the invention, the key code may be utilized to provide authorization. In an illustrative embodiment, the key code may be utilized to provide authorization to access a particular media exchange function. In this regard, the key code may be utilized to access and receive certain information related to a media exchange function. In another aspect of the invention, utilizing key codes that provide authorization may require payment of a fee.

Aspects of the invention may also include a system for providing media content. The system may include at least one processor that may receive a key code corresponding to at least one media exchange function associated with a media program generated by a third (3^{rd}) party media provider 103. The processor may be a media processing system processor, a media management system processor, a computer processor, a media exchange software processor, a media peripheral processor or a combination thereof. For example, the media processing system 101 may communicate the key code and/or data representative of the key code to the third (3^{rd}) party media provider. In response to the communicated key code and/or data representative of the key code, the media processing system 101 may receive media content corresponding to the key code and at least one media exchange function from at least the third (3^{rd}) party media provider.

In another aspect of the invention, the media processing system 101 may determine whether the key code and media exchange function is associated with an existing media exchange function. If the key code is associated with the existing media exchange function, the media processing system 101 may request the received media content corresponding to the key code and media exchange function from the third (3^{rd}) party media provider 103. In instances where the key code is unassociated with an existing media exchange function, the media processing system 101 may initiate the creation of a new media exchange function corresponding to the key code.

The media processing system 101 may facilitate transfer of the received media content corresponding to the key code and media exchange function from the third (3^{rd}) party media provider 103. The media processing system 101 may also be adapted to cause at least a portion of the received media content corresponding to the key code and media exchange function to be presented to a user. In this regard, the media processing system 101 may cause at least a portion of the received media content corresponding to the key code and media exchange function to be displayed on a television screen of or coupled to the media processing system. A user may also be notified by the media processing system 101 of availability of a key code associated with a media program generated a third (3^{rd}) party media provider 103. The media processing system 101 may also be adapted to receive the key code generated by a remote control device, a keyboard, a scanning device, an audio processing device or a combination thereof.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing on a television screen within a home, access to selected ones of a plurality of media files stored outside of the home, the method comprising:
associating, outside of the home, a plurality of key sequences with a corresponding plurality of media files;
receiving one of said plurality of key sequences via manual input within the home; and
communicating one of the plurality of media files for display on the television screen, said one of said plurality of media files corresponding to at least one of said associated plurality of key sequences.

2. The method according to claim 1, further comprising determining whether said received one of said received plurality of key sequences is associated with an existing function for media exchange.

3. The method according to claim 2, further comprising if said received one of said received plurality of key sequences is associated with said existing function for media exchange, requesting at least one media file associated with said existing function for media exchange.

4. The method according to claim 2, further comprising if said received one of said received plurality of key sequences is associated with said existing function for media exchange, receiving at least one media file associated with said existing function for media exchange.

5. The method according to claim 2, further comprising if said received one of said received plurality of key sequences is associated with said existing function for media exchange, displaying at least one media file associated with said existing function for media exchange.

6. The method according to claim 1, further comprising notifying a user of said one of said plurality of key sequences that is associated with a function for media exchange.

7. A machine-readable storage having stored thereon, a computer program having at least one code section for providing on a television screen within a home, access to selected ones of a plurality of media files stored outside of the home, the at least one code section being executable by a machine for causing the machine to perform steps comprising:
associating, outside of the home, a plurality of key sequences with a corresponding plurality of media files;
receiving one of said plurality of key sequences via manual input within the home; and
communicating one of the plurality of media files for display on the television screen, said one of said plurality of media files corresponding to at least one of said associated plurality of key sequences.

8. The machine-readable storage according to claim 7, further comprising code for determining whether said received one of said received plurality of key sequences is associated with an existing function for media exchange.

9. The machine-readable storage according to claim 8, further comprising code for requesting at least one media file associated with said existing function for media exchange, if said received one of said received plurality of key sequences is associated with said existing function for media exchange.

10. The machine-readable storage according to claim 8, further comprising code for receiving at least one media file associated with said existing function for media exchange, if said received one of said received plurality of key sequences is associated with said existing function for media exchange.

11. The machine-readable storage according to claim 8, further comprising code that causes display of least one media file associated with said existing function for media exchange, if said received one of said received plurality of key sequences is associated with said existing function for media exchange.

12. The machine-readable storage according to claim 7, further comprising code for notifying a user of said one of said plurality of key sequences that is associated with a function for media exchange.

13. A method for providing media content, the method comprising:
receiving a key code corresponding to at least one media exchange function associated with a media program generated by a third (3^{rd}) party provider of media, said key code corresponding to at least one key sequence;
communicating at least one of said key code and data representative of said key code to said third (3^{rd}) party media provider; and
in response to said communicated at least one of said key code and data representative of said key code, receiving media content corresponding to said key code and said at least one media exchange function from at least said third (3^{rd}) party media provider.

14. The method according to claim 13, further comprising determining whether said key code is associated with an existing media exchange function.

15. The method according to claim 14, further comprising if said key code is associated with said existing media exchange function, requesting said received media content corresponding to said key code and said at least one media exchange function from said third (3^{rd}) party media provider.

16. The method according to claim 14, further comprising if said key code is unassociated with said existing media exchange function, initiating the creation of a new media exchange function corresponding to said key code.

17. The method according to claim 13, further comprising transferring said received media content corresponding to said key code and said at least one media exchange function from said third (3^{rd}) party media provider to a media processing system.

18. The method according to claim 13, further comprising presenting at least a portion of said received media content corresponding to said key code and said at least one media exchange function to said user.

19. The method according to claim 13, further comprising displaying at least a portion of said received media content corresponding to said key code and said at least one media exchange function on a television screen of said media processing system.

20. The method according to claim 13, further comprising notifying a user of availability of said key code associated with a media program generated by said third (3^{rd}) party media provider.

21. A system for providing media content, the system comprising:
at least one processor that receives a key code corresponding to at least one media exchange function associated with a media program generated by a third (3^{rd}) party media provider;
said at least one processor communicates at least one of said key code and data representative of said key code to said third (3^{rd}) party media provider; and
in response to said communicated at least one of said key code and data representative of said key code, said at least one processor receives media content corresponding to said key code and said at least one media exchange function from at least said third (3^{rd}) party media provider.

22. The system according to claim 21, wherein said at least one processor determines whether said key code is associated with an existing media exchange function.

23. The system according to claim 22, wherein said at least one processor requests said received media content corresponding to said key code and said at least one media exchange function from said third (3^{rd}) party media provider if said key code is associated with said existing media exchange function.

24. The system according to claim 22, wherein said at least one processor initiates the creation of a new media exchange function corresponding to said key code if said key code is unassociated with said existing media exchange function.

25. The system according to claim 21, wherein said at least one processor transfers said received media content corresponding to said key code and said at least one media exchange function from said third (3^{rd}) party media provider to a media processing system.

26. The system according to claim 21, wherein said at least one processor causes at least a portion of said received media content corresponding to said key code and said at least one media exchange function to be presented to said user.

27. The system according to claim 21, wherein said at least one processor causes at least a portion of said received media content corresponding to said key code and said at least one media exchange function to be displayed on a television screen of said media processing system.

28. The system according to claim 21, wherein said at least one processor notifies a user of availability of said key code associated with a media program generated by said third (3^{rd}) party media provider.

29. The system according to claim 21, further comprising receiving said key code generated by at least one of a remote control device, a keyboard, a scanning device and an audio processing device.

30. The system according to claim 21, wherein said at least one processor is at least one of a media processing system processor, a media management system processor, a computer processor, a media exchange software processor and a media peripheral processor.
